(19) United States
(12) Patent Application Publication
(10) Pub. No.: US 2026/0243955 A1
(43) Pub. Date: Aug. 20, 2026

(54) CHIP MODE CONVERTER FOR LIGHT SOURCE ISOLATION

(71) Applicant: The Regents of the University of California, Oakland, CA (US)

(72) Inventors: Andrew Grieco, La Jolla, CA (US); Dhaifallah Almutairi, San Diego, CA (US); Andrew Ingram, San Diego, CA (US); Naif Alshamrani, San Diego, CA (US); Prabhav Gaur, La Jolla, CA (US); Yeshaiahu Fainman, San Diego, CA (US)

(21) Appl. No.: 19/152,623

(22) PCT Filed: Jan. 30, 2024
(86) PCT No.: PCT/US2024/013616

§ 371 Date: Jul. 31, 2025

Related U.S. Application Data
(60) Provisional application No. 63/482,544, filed on Jan. 31, 2023.

(51) Int. Cl. G02B 6/122; G02B 6/12

(52) U.S. Cl. CPC G02B 6/1228; G02B 6/12004; G02B 2006/12061; G02B 2006/12157; G02B 2006/12176

(57) ABSTRACT

Optical devices and methods of forming optical devices are disclosed. In one embodiment, an optical device includes a first waveguide having a first width and including a body section and two or more tapering arm sections connected to the body section at a junction section, each tapering arm section connected to the body section through a bent section, and a second waveguide having a second width and including a first end spaced apart from the junction section of the first waveguide by a first gap.

### CROSS-REFERENCE TO RELATED APPLICATION

This patent document claims priority to and benefits of U.S. Provisional Patent Application No. 63/482,544, titled “CHIP MODE CONVERTER FOR LIGHT SOURCE ISOLATION” and filed on Jan. 31, 2023. The entire contents of the before-mentioned patent application are incorporated by reference as part of the disclosure of this document.

### TECHNICAL FIELD

The patent document generally relates to an optical isolator or attenuator.

### BACKGROUND

Optical isolators are a critical optical component because they enhance the stability of laser gain cavities, as well as improve the measurement precision of passive devices by preventing parasitic resonances. Most optical isolator designs rely on magneto-optic materials that are not compatible with CMOS processing and thus may not be incorporated into common integrated photonic material platforms.

### SUMMARY

The disclosed technology can be implemented in some embodiments to provide a photonic valve device that functions as a passive optical isolator. The disclosed technology can also be implemented in some embodiments to provide a passive chip-scale optical attenuator that includes asymmetric waveguides separated by a small gap.

In some embodiments of the disclosed technology, an optical device may include a first waveguide having a first width and including a body section and two or more tapering arm sections connected to the body section at a junction section, each tapering arm section connected to the body section through a bent section, and a second waveguide having a second width and including a first end spaced apart from the junction section of the first waveguide by a first gap.

In some embodiments of the disclosed technology, a method of forming an optical device may include forming a first pattern of photoresist material over a wafer that includes a bottom layer and a device layer disposed on the bottom layer by performing a photolithography process, forming a first waveguide and a second waveguide on the bottom layer by removing part of the device layer through an etching process using the first pattern of photoresist material as an etching mask, and forming a first material layer in an exposed portion of the bottom layer that surrounds the first and second waveguides, wherein the first waveguide has a first width and includes a body section and two or more tapering arm sections connected to the body section at a junction section, and each tapering arm section is connected to the body section through a bent section, wherein the second waveguide has a second width and includes a first end spaced apart from the junction section of the first waveguide by a first gap, wherein the second width is smaller than the first width.

In some embodiments of the disclosed technology, an optical device may include a plurality of unit optical devices, and a plurality of optical combiners configured to connect the plurality of unit optical devices in cascade, wherein each of the plurality of unit optical devices comprises a first waveguide having a first width and including a body section and two or more tapering arm sections connected to the body section at a junction section, each tapering arm section connected to the body section through a bent section, and a second waveguide having a second width and including a first end spaced apart from the junction section of the first waveguide by a first gap.

The above and other aspects and implementations of the disclosed technology are described in more detail in the drawings, the description, and the claims.

### BRIEF DESCRIPTION OF THE DRAWINGS

FIG. 1 shows an example optical attenuator that includes two waveguides with a non-reciprocal section that is separated by a small gap.

FIG. 2A shows an example width of a right waveguide. FIG. 2B shows an example width of a left waveguide. FIG. 2C shows an example outer bend length for a left waveguide. FIG. 2D shows an example of a tapering length. FIG. 2E shows an example gap between two waveguides. FIG. 2F shows an example of a tapering length left waveguide.

FIG. 3 shows an example of a photonic valve device implemented based on some embodiments of the disclosed technology.

FIGS. 4A and 4B show a finite-difference time-domain (FDTD) simulation of the total power within the photonic valve device.

FIG. 5 shows a field transmission spectrum of the simulation of the photonic valve device implemented based on some embodiments of the disclosed technology.

FIG. 6 shows a field reflection spectrum of the simulation of the photonic valve device implemented based on some embodiments of the disclosed technology.

FIG. 7 shows an experimental design of the fabricated sample where the tesla valve is embedded into a racetrack.

FIGS. 8A-8C show an electron micrograph of the fabricated photonic valve device.

FIG. 9 shows experimental transmission spectra of the photonic valve device contained within a ring resonator.

FIG. 10 shows an example of a circulator design using the optical tesla valve based on some embodiments of the disclosed technology.

FIG. 11 shows an example of the optical valve device.

FIG. 12 shows an example method of forming an optical device based on some implementations of the disclosed technology.

### DETAILED DESCRIPTION

The disclosed technology can be implemented in some embodiments to provide a photonic valve device that functions as a passive optical isolator. The disclosed technology can also be implemented in some embodiments to provide a passive chip-scale optical attenuator that includes asymmetric waveguides separated by a small gap.

Waveguides implemented based on some embodiments of the disclosed technology permit optical propagation in one direction while preventing or limiting optical propagation in the opposite direction by redirecting light using a pair of transverse waveguides in a Y-splitter configuration. In some embodiments of the disclosed technology, the attenuator may be formed on silicon on insulator (SOI). The attenuator implemented based on some embodiments can offer significant isolation, wide bandwidth, and polarization independent operation that is comparable with commercial isolators.

The disclosed technology can be implemented in some embodiments to provide a passive chip-scale optical attenuator that can be used as an optical isolator with efficient unidirectional transmission of a laser field and strong attenuation of reflected light to prevent back reflection into the cavity of the laser. The device implemented in some embodiments operates in a broad spectral range and has a small footprint compared to the conventional interferometric magneto-optic isolator. Additionally, the device implemented in some embodiments can be cascaded to improve the total isolation as well as enable heterogeneous integration of tunable light sources.

The device implemented based on some embodiments is broadband and has a small footprint compared to the conventional interferometric and resonance magneto-optic isolator enabling wavelength division multiplexing (WDM) operation on a chip. Additionally, the device implemented in some embodiments is all passive silicon optical isolator and CMOS compatible which provides a high isolator for transverse electric (TE) and transverse magnetic (TM) polarizations.

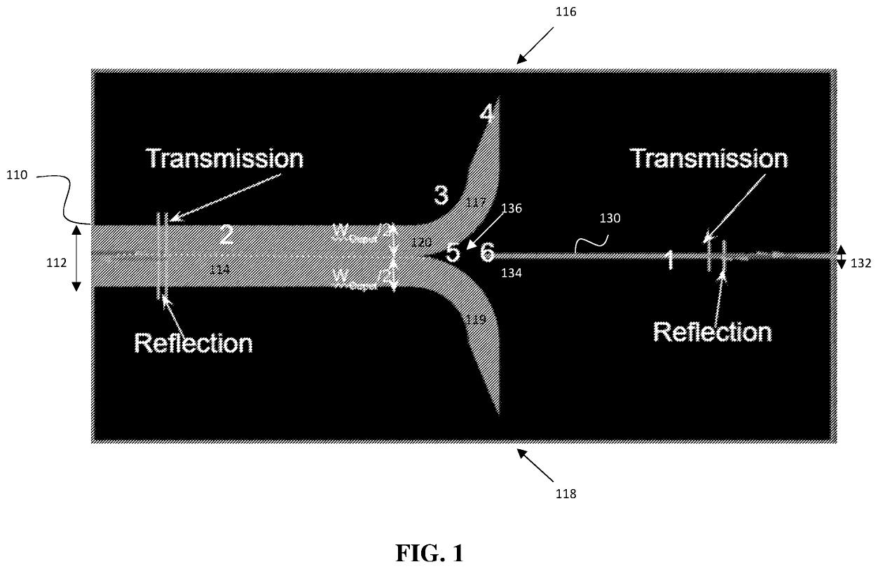

FIG. 1 shows an example optical attenuator that includes two waveguides with a non-reciprocal section that is separated by a small gap. The device allows light to propagate only from the smaller waveguide to the wider waveguide and not vice versa. The light propagating from the wider side waveguide is not allowed to propagate to the thinner waveguide.

The design and simulation stage involves running a finite-difference time-domain (FDTD) simulation using software and inverse design. In some embodiments of the disclosed technology, as shown in FIG. 1, the features of an optical attenuator implemented may be determined based on (1) width of right waveguide, (2) width of left waveguide, (3) outer bend length, (4) tapering length left waveguide, (5) gap between the two waveguides, and (6) tapering length left waveguide.

Referring to FIG. 1, in some embodiments, an optical device may include a first waveguide 110 and a second waveguide 130. In some embodiments, the first waveguide 110 may have a first width 112 and may include a body section 114 and two or more tapering arm sections 116, 118 connected to the body section 114 at a junction section 120, and each tapering arm section 116, 118 may be connected to the body section through a bent section 117, 119. In some embodiments, the second waveguide 130 may have a second width 132 and may include a first end 134 spaced apart from the junction section 120 of the first waveguide 110 by a first gap 136. In some embodiments, the second width 132 is smaller than the first width 112.

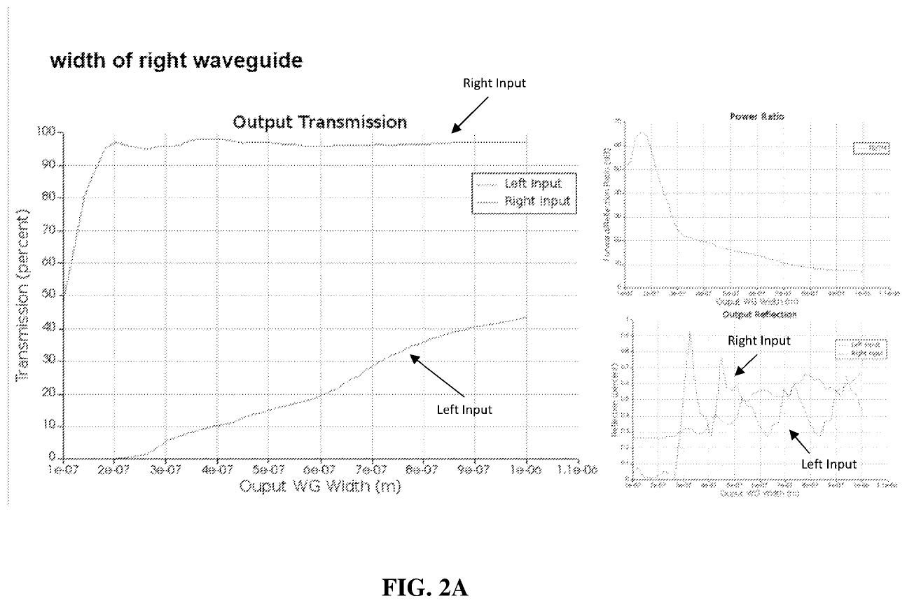

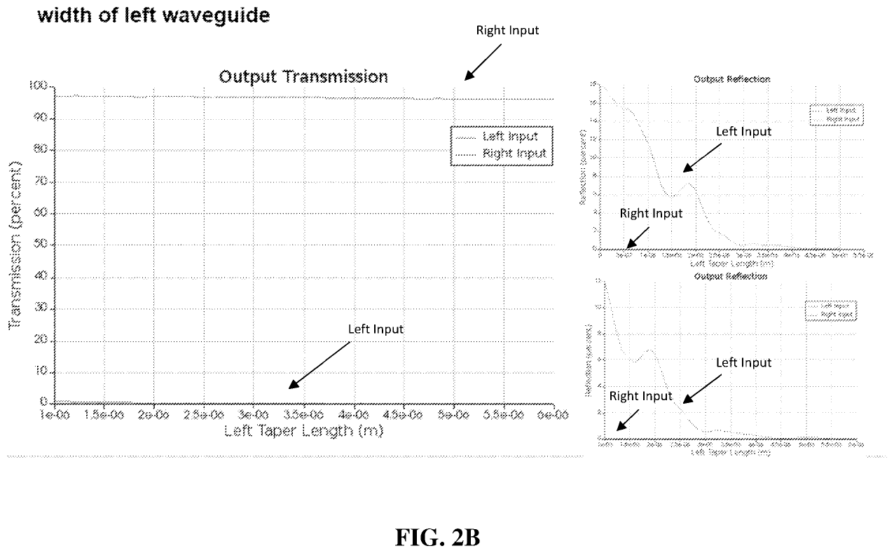

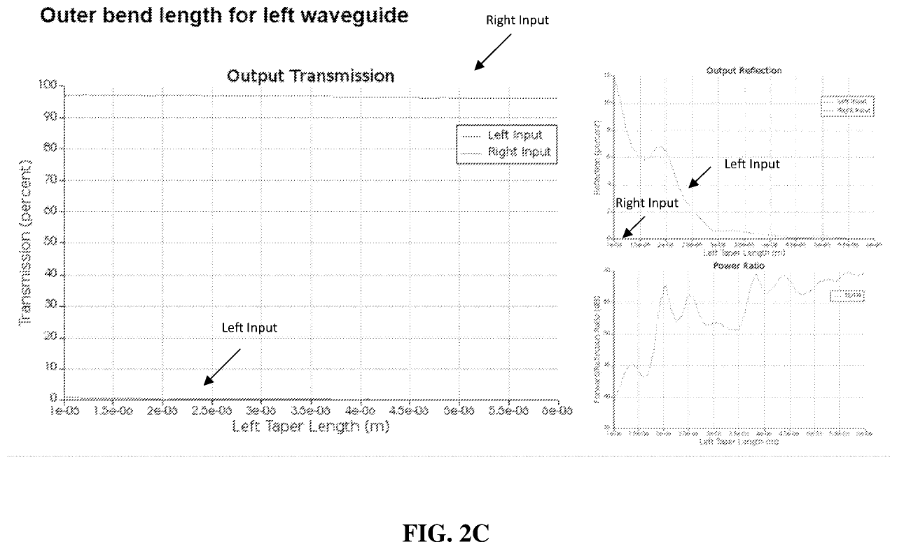

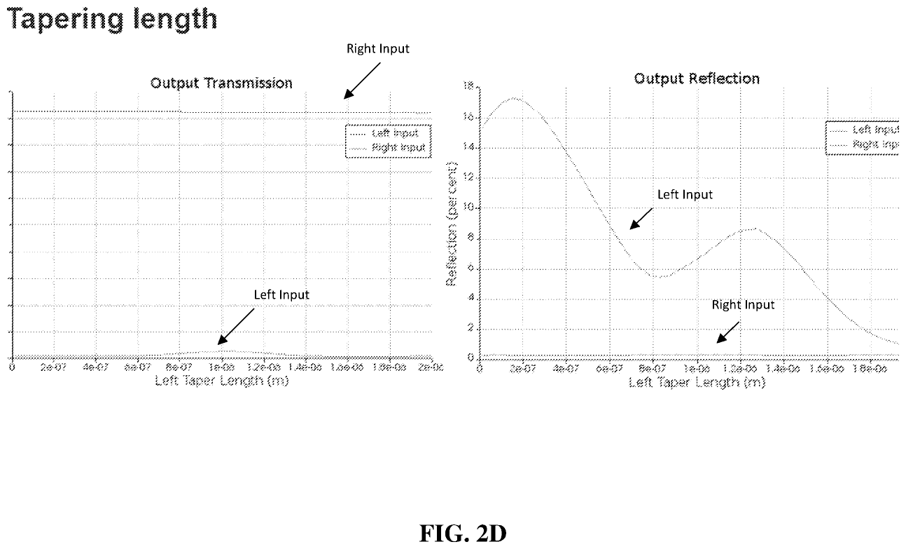

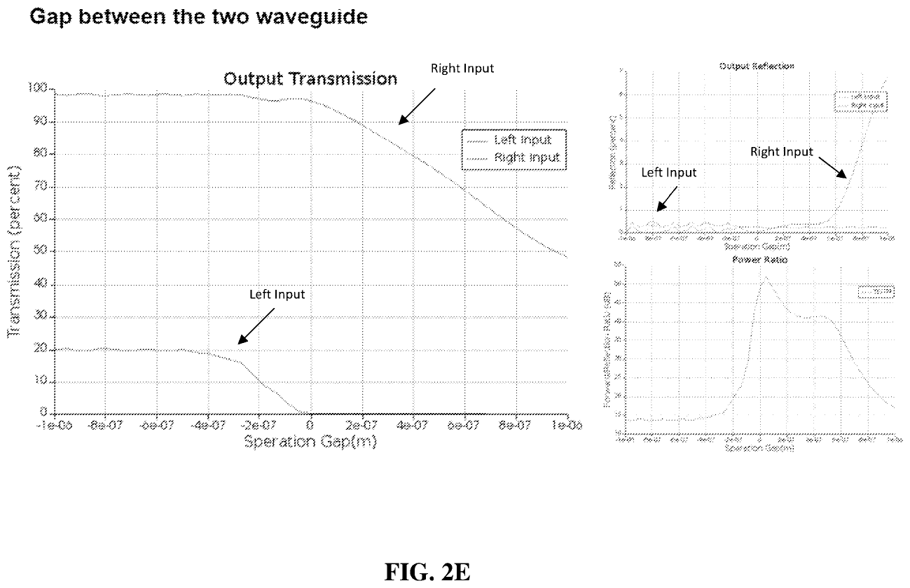

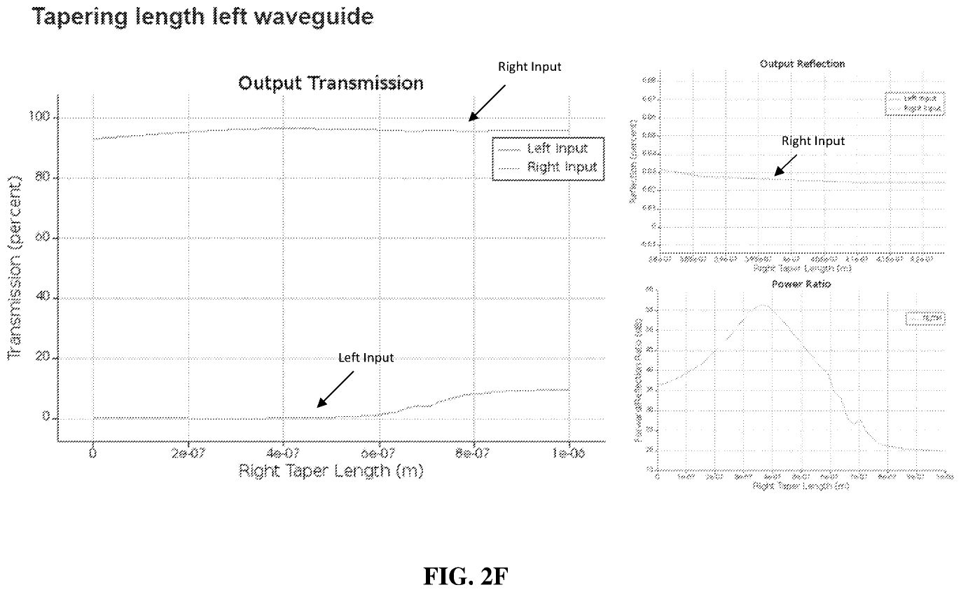

FIG. 2A shows an example width of a right waveguide. FIG. 2B shows an example width of a left waveguide. FIG. 2C shows an example outer bend length for a left waveguide. FIG. 2D shows an example of a tapering length. FIG. 2E shows an example gap between two waveguides. FIG. 2F shows an example of a tapering length left waveguide.

Referring to FIG. 2A, the best width of the right waveguide can be determined as shown in FIG. 1, and the best value is the maximum transmission from the right input and at the same time allows minimum transmission from the left input. In this case, the best value is 200 nm. Referring to FIG. 2B, the best width of the left waveguide can be determined as shown in FIG. 1, and the best value is the maximum transmission from the right input and at the same time allow minimum transmission from the left input. In this case the best value is 2.5 μm. Referring to FIG. 2C, the best width of the left waveguide can be determined as shown in FIG. 1, and the best value is the minimum reflection from the right reflection monitor (right input) and at the same time allows minimum reflection from the left reflection monitor (left input). In this case, the best value is 4 μm. Referring to FIG. 2D, the best width of the left waveguide can be determined as shown in FIG. 1, and the best value is the minimum reflection from the right reflection monitor (right input) and at the same time allows minimum reflection from the left reflection monitor (left input). In this case, the best value is 3 μm. Referring to FIG. 2E, the best width of the right waveguide can be determined as shown in FIG. 1, the best value is the maximum transmission from the right input and at the same time allows minimum transmission from the left input. In this case, the best value is 200 nm. Referring to FIG. 2F, the best width of the left waveguide can be determined as shown in FIG. 1, and the best value is the minimum reflection from the right reflection monitor (right input) and at the same time allows minimum reflection from the left reflection monitor (left input). In this case, the best value is 360 nm.

The disclosed technology can be implemented in some embodiments to provide a device that includes two asymmetric waveguides that are separated by a small gap. In some implementations, the transmission of the device can behave in a non-reciprocal manner such that the transmission between the waveguides from one direction is less than from the opposite direction. In some implementations, the device allows light to propagate only from a smaller waveguide to a wider waveguide and not vice versa. The light propagating from the wider side waveguide is scattered away and does not propagate to the smaller or thinner waveguide.

An optical isolator is a critical optical component that can improve the performance of lasers by preventing the reflected light from destabilizing the gain cavity. The isolator can also improve the measurement precision in passive devices by preventing unwanted parasitic resonances. Some isolator designs often rely on magneto-optic materials, which are not CMOS compatible. As a result, it is difficult to incorporate them into common integrated photonic material platforms. In addition, the magneto-optic material used in such isolators may have a nonreciprocal material response to achieve isolation. It is also possible to achieve isolation through the use of optical nonlinearity, time dependent gating, and optical absorption. However, these techniques are not commonly applied. Some other approaches use optical nonlinearity or time dependent modulation, but they have performance limitations that make them suitable only in particular operating regimes.

The disclosed technology can be implemented in some embodiments to provide an optical device that functionally behaves as a passive optical isolator. In some embodiments of the disclosed technology, the term “optical Tesla valve” can be used to indicate such an optical device. This device can achieve more than 45 dB isolation over a broad bandwidth of 100 nm with no for applied electrical or magnetic fields (which is performance on par with existing commercial magneto-optic isolators). Moreover, the device footprint dimension is smaller than 50 μm by 50 μm. Such a device can be fabricated with a single lithography step and is compatible with global CMOS foundries. It is also compatible with gain material and can be directly integrated with lasers and amplifiers.

The disclosed technology can be implemented in some embodiments to provide a compact optical device that can achieve broadband performance similar to commercial magneto-optic isolators. Furthermore, the device implemented based on some embodiments can be constructed in waveguide material that is passive, linear, and time invariant which makes it compatible with CMOS fabrication processes. This is a significant advantage over magneto-optic isolators, which are not CMOS compatible. In addition, the device implemented based on some embodiments is compatible with gain materials and thus can be integrated directly into laser designs. This is important because laser isolation is the primary application of optical isolators. Furthermore, the device implemented based on some embodiments can be used as the basis for constructing devices such as circulators.

The disclosed technology can be implemented in some embodiments to provide a component for integrated optical foundries. Currently there is no commercially viable isolator design that is compatible with the nanofabrication techniques used photonics foundries. The device implemented based on some embodiments of the disclosed technology is compatible with these processes. Furthermore, with regard to lasers, it can be integrated directly into the device layer. This is a significant advantage that even conventional isolators cannot accomplish.

The disclosed technology can be implemented in some embodiments to provide a photonic valve device that functions as a passive optical isolator. In some embodiments, the photonic valve device occupies a small footprint and can achieve large isolation over a broad bandwidth with no applied electrical or magnetic fields. The design implemented based on some embodiments can be fabricated using commercial photonic foundries. It is also compatible with gain material and can be directly integrated with lasers and amplifiers.

Optical nonreciprocity is a physical phenomenon that permits the optical field to propagate in one direction while prohibiting it from propagating in the opposite direction. It is the key to realizing essential components such as optical isolators, circulators, and directional amplifiers. In some implementations, optical isolators may be realized by breaking time-reversal symmetry to achieve nonreciprocal behavior. This is achieved using magneto-optical materials via the Faraday effect. Notable drawbacks of magneto-optic materials include the relatively high inherent optical losses, and their incompatibility with photonic foundry processes. This places a crippling restriction on integrated photonics devices and systems, as it renders nonreciprocal components inaccessible. It also complicates their engineering aspect since it prohibits the direct miniaturization of many conventional optical designs.

For systems composed of reciprocal materials, nonreciprocal behavior may be prohibited in devices that are passive, linear, and time-invariant. Consequently, the various approaches to realizing nonreciprocal devices may be categorized based on which of these conditions that they violate. The three categories may be summarized as follows: utilizing loss/gain to induce nonreciprocity, modulation of system permittivity using nonlinear effects, and utilization of temporally varying device parameters. However, these approaches have had limited success and typically have poor isolation ratio, narrow bandwidth, or limited operating conditions.

Recently, a class of devices has been developed that display behavior phenomenologically similar to that of a conventional nonreciprocal devices, but which cannot technically be classified as nonreciprocal because they occur in linear time-invariant (LTI) systems and are made of reciprocal materials. These devices operate by engineered spatial asymmetry, typically in heterogeneous photonic crystal structures. This class of devices is one of the most promising avenues for integrated photonics to replicate the functionality of classical nonreciprocal components, at least in a sense suitable for engineering purposes. In some implementations, these devices can be referred to as pseudo-nonreciprocal, in order to distinguish them from nonreciprocal devices in the strict sense.

In some implementations, pseudo-isolator designs based on heterogeneous photonic crystal structures may have a large footprint since many photonic crystal periods are necessary to confine the light. Furthermore, since periodic structures rely on phase matching, pseudo-isolator designs based on heterogeneous photonic crystal structures may have a narrow operating bandwidth. Pseudo-isolator designs based on heterogeneous photonic crystal structures may also suffer from high loss, although it is not clear that this is fundamental to their operation. Finally, pseudo-isolator designs based on heterogeneous photonic crystal structures do not confine the rejected optical power, scattering it into free space. This risks unwanted coupling of the scattered field at some other point on the photonic circuit.

The disclosed technology can be implemented in some embodiments to address these issues by providing a photonic valve device. In some embodiments of the disclosed technology, such a photonic valve device may be referred to as “photonic Tesla valve” because of the superficial similarities it shares with the fluidic Tesla valve invented by Nikola Tesla. This device is a pseudo-isolator that operates using engineered spatial asymmetry. The adiabatically tapered design maximizes operating bandwidth while minimizing the overall footprint and allows the device to function for both polarizations. The rejected optical power remains confined and can be routed away in a controlled fashion. Most importantly, the design is compatible with CMOS and photonic foundry fabrication processes.

The magneto-optic effect can be defined as an electromagnetic wave interaction with matter under the influence of a magnetic field, where the magnetic field alters the medium's optical properties. However, magnetic materials are lossy because they have nontrivial magnetic dipoles, which can physically be thought of as small loops of current. This means there is a nontrivial amount of moving charge carriers in the material, and moving carriers are known to attenuate the optical field. Consequently, enhancing the nonreciprocity by increasing the magneto-optic response increases the overall loss of the material. When considering waveguide-based isolators and circulators, the nonreciprocal phase shift is achieved either by applying a perpendicular magnetic field, known as the Faraday effect, or a perpendicular magnetic field, known as the Voigt effect. This method is considered to have the highest isolation ratio among the different methods, ranging from 20-30 dB.

Nevertheless, this approach is incompatible with CMOS and nanophotonic fabrication processes due to lattice mismatch. Much research has been done on epitaxial integration of III-V materials directly on silicon, but it has had limited success. Heterogeneous integration through wafer bonding has been used successfully to achieve integrated optical isolators, but subsequently increases the device's overall footprint and reduces its efficiency.

One alternative to breaking the time-reversal symmetry is to utilize the loss of the device. Phase lags happen when the loss is induced; this lag is independent of the propagation direction. Utilizing loss under multiple channels with interference can cause optical nonreciprocity. It is essential to mention that experimentally tuning loss and gain through calibrating the coupling between the waveguide is challenging and not easy to realize due to random fabrication variations. Although this approach is easily integrated into the current CMOS process, breaking the time-reversal symmetry requires strict experimental conditions, which limits the use of the approach; Moreover, the experimental results demonstrate only a modest isolation ratio equal to 16 dB.

Another approach is to use the nonlinear effect of certain optical materials to break Lorentz reciprocity. With this approach, dielectric properties depend on the field strength; thus, the forward and backward waves exhibit different dielectric permittivity distributions and can produce a nonreciprocal response. Spatial asymmetry and nonlinear effects give rise to direction-dependent behavior. However, a small amplitude wave can still propagate through a nonlinear isolator, so the device is nonreciprocal only under particular input power. These limitations have caused some authors to question whether this type of device should, strictly speaking, be called an isolator. As a further limitation, specific nonlinear materials might prove challenging to integrate into the current CMOS fabrication process.

Another solution to avoid the limitation in the nonlinear isolator is to use a time-variant device. Time-variant devices require active modulation of the permittivity to break the time-reversal symmetry. There are several ways to realize this approach, such as using phase modulation and interband optical transition. However, these approaches significantly lower the isolation ratio for needed applications, typically ranging from 2 to 10 dB. Alternatively, the time-variant approach can be realized by optoelectronic, mainly parametric modulation, increasing the isolation ratio to 40 dB but reducing the bandwidth to a couple of nanometers. Finally, coherent optically driven acoustic waves can be used to create unidirectional variable amplification or attenuation depending on the direction of the wave. A pump laser is needed to generate this effect, complicating the silicon photonics platform implementation.

Spatial asymmetry can permit optical transmission of a preferred direction while preventing other directions from propagating. This approach cannot be characterized as a strict isolator due to not being able to show that the scattering matrix of the device is asymmetric, which means, strictly speaking, the Lorentz reciprocity is not broken. Nonetheless, the device can operate phenomenologically like an isolator if some of the input ports are restricted, and can be used to solve the same type of engineering problems as conventional isolators. In the past couple of years, there has been much contention regarding the technical definition of an isolator. Using conventional reasoning, if a device is linear, time-independent, and composed of reciprocal materials, then strictly speaking it cannot be called an isolator. However, this definition is so strict that it does not entirely coincide with how the term isolator is used in the colloquial sense. This leads to confusion because a class of devices functions as isolators in the colloquial sense but not in the strict mathematical sense. To avoid such confusion, here we will refer to these devices as pseudo-isolators.

Spatial asymmetry is used in photonics crystals to create a preferable path for forward propagating waves and scatters the backward propagating wave. The system is passive, linear, and time-independent, and compatible with the CMOS process. However, the current demonstration for such an approach suffer from large footprints since they are based on photonic crystal structures, in which many periods are necessary in order to confine the light. Furthermore, since periodic structures rely on phase matching, they have a narrow bandwidth of around 50 nm and an extremely high loss ranging from 90-92%. They also do not confine the rejected power, scattering it into free space. This risks unwanted coupling of the scattered field at some other point on the photonic chip.

The disclosed technology can be implemented in some embodiments to address the issues discussed above by providing a pseudo-isolator (optical Tesla valve) that operates using engineered spatial asymmetry to facilitate asymmetric transmission depending on the direction of optical propagation. The optical Tesla valve operates on a broadband bandwidth and occupies a compact area. Furthermore, the rejected (unwanted) power remains confined, and can be routed away from the device to avoid unwanted interaction. Moreover, the design can be fabricated in a single lithography and etching process step and is compatible with CMOS and photonic foundry fabrication processes. The device is also a linear system hence operates independently of the total power level. The device can be integrated with many existing lasers sources that are employed in data centers and optical telecommunication applications, which often demand high isolation to prevent destabilizing of the laser cavity and prevent amplification of the unwanted signal. Furthermore, the design can easily be extended to other material systems to cover additional optical windows.

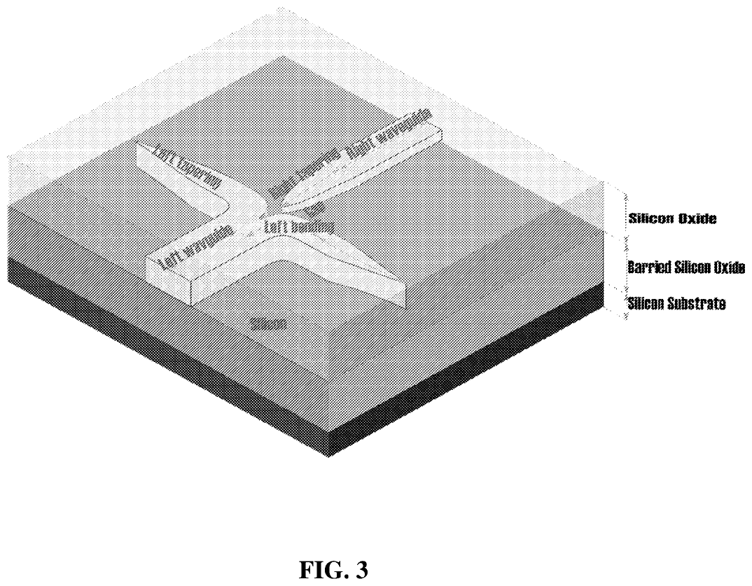

FIG. 3 shows an example of a photonic valve device (photonic Tesla valve) implemented based on some embodiments of the disclosed technology. In some implementations, the terms “photonic Tesla valve” and “optical Tesla valve” can be used to indicate the photonic valve device (optical valve device). In some embodiments, the photonic valve device includes a tapered waveguide and a Y-splitter that are separated by a small gap. Light incident from the right is transmitted effectively across the gap, whereas light incident from the left is directed laterally out of the photonic circuit.

In some embodiments of the disclosed technology, the photonic valve device includes a waveguide nested within a Y-splitter and separated by a small gap as illustrated in FIG. 3. The input and output are adiabatically tapered to support only a single guided mode. When excited from the direction of the nested waveguide, the optical field is transmitted to the Y-splitter. When excited from the direction of the Y-splitter the optical field is directed laterally out of the device where it is dissipated through the horns, and nothing is transmitted to the nested waveguide. The device functions as a pseudo-isolator such that excitation in one direction is transmitted, and excitation in the opposite direction is dissipated.

In some implementations, the curved sections of the photonic Tesla valve may render it impossible to analyze using ordinary coupled-mode theory. Modes in curved structures may be analyzed in terms of conformal mapping, which in this case cannot be decomposed into a simple orthogonal set due to the presence of multiple bends in different orientations. Instead, the device can be understood in terms of non-orthogonal coupled-mode theory. A significant consequence of this formalism is that the coupling coefficients are not in general Hermitian, such that κₗₘ≠κ*ₘₗ. In this representation, a reversal of the coefficient subscripts is equivalent to swapping the input and output modes, and the conjugation is equivalent to reversing the propagation direction. This suggests that apparent non-reciprocal behavior could be observed in such systems. The theoretical implications of non-orthogonality have also been considered in terms of the scattering matrix S. It is verified that the symmetry is broken such that S≠S^{T}, instead being replaced by a more relaxed relationship involving generalized orthogonality coefficients. The case of non-orthogonality does not seem to be accounted for in conventional overviews on the subject of reciprocity, so it remains a largely unexplored area of research.

In some implementations, an analysis based on port restricted scattering matrixes is also relevant to the photonic Tesla valve. Consider an input to the device that produces a particular output. If the output fields were to have their propagation direction reversed such that they were instead input into the device, the field that they would produce would be the backward propagating version of the original input. Essentially, the loophole that allows isolation-like behavior (or pseudo-isolation) to occur results from the ability to restrict the ports of the device such that some can be used as outputs but not as inputs. Consequently if some output fields corresponding to some input cannot be reversed, then the input cannot be reconstructed by reciprocity. In the optical Tesla valve, the restricted ports are the transverse ports. Any energy exiting them can be scattered into free space or they can be terminated in an absorber. By encasing the device or otherwise obscuring the ports, the possibility of using them as reciprocal inputs can be eliminated. The device will therefore respond in an asymmetric manner that is suitable for the same engineering purposes as a conventional isolator.

In some implementations, finite-difference time-domain (FDTD) simulations may be used to optimize the device parameters according to Table 1. The optimization may maximize the forward transmitted and minimize the backward reflected power. In some implementations, the precise tapering profile in the device is not critical so long as it occurs gradually enough that excess loss is minimal. In some implementations, the most important parameter is the gap size, which requires careful optimization.

TABLE 1

| | | |
|---|---|---|
| Parameter | TE | TM |

| | | | | |
|---|---|---|---|---|
| Left waveguide width | 2.5 | um | 5 | um |
| Right waveguide width | 200 | nm | 0.55 | um |
| Left waveguide taper | 3 | um | 4 | um |
| Right waveguide taper | 0.397 | um | 1.5 | um |
| Left waveguide outer radius | 4 | um | 6 | um |
| Left waveguide bending angle | 90 | degrees | 90 | degrees |
| Separation gap | 0.508 | um | 0.636 | um |
| Design height | 0.22 | um | 0.22 | um |
| Isolation ratio | 62 | dB | 35 | dB |

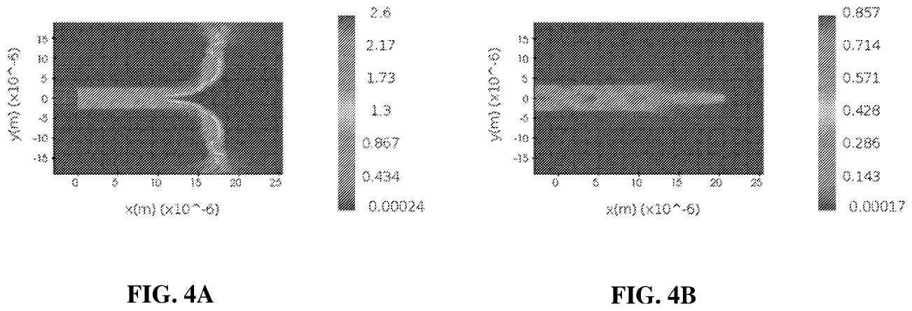

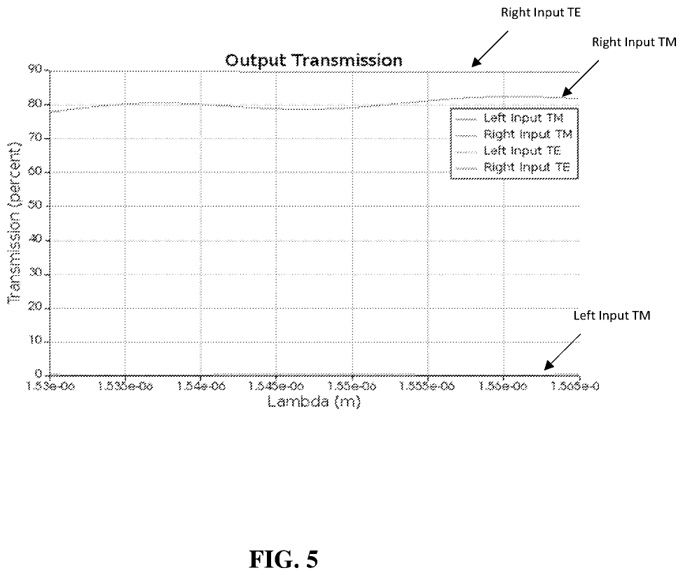

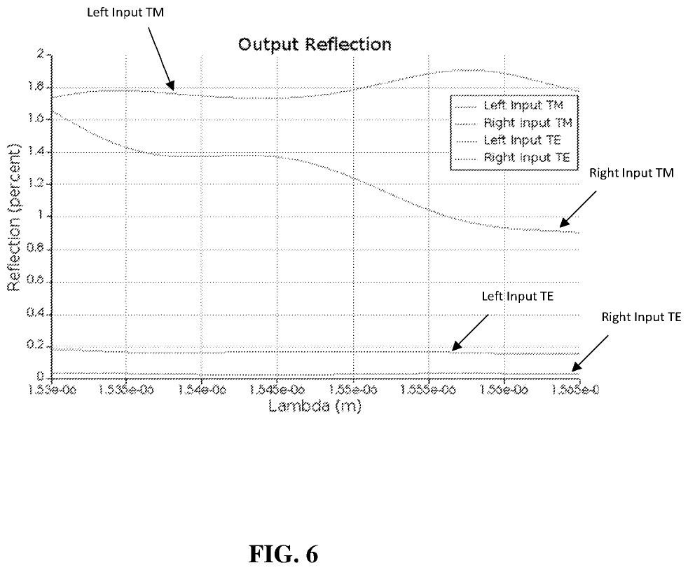

FIGS. 4A and 4B show a finite-difference time-domain (FDTD) simulation of the total power within the photonic valve device (photonic Tesla valve). Specifically, FIG. 4A shows an “OFF” state, and FIG. 4B shows an “ON” state. FIG. 5 shows a field transmission spectrum of the simulation of the photonic valve device implemented based on some embodiments of the disclosed technology. The simulation includes transverse electric (TE) and transverse magnetic (TM) polarization over a bandwidth of 100 nm. FIG. 6 shows a field reflection spectrum of the simulation of the photonic valve device implemented based on some embodiments of the disclosed technology. The simulation includes TE and TM polarization over a bandwidth of 100 nm.

The total simulated power within the optimized device in both operating states is illustrated in FIGS. 4A-4B, and the simulated transmission spectrum is illustrated in FIG. 5. To clarify, the left to right propagation is considered as the unwanted propagation direction, and the right to left propagation is the desired propagation direction. For the TE polarization, the forward transmission exceeds 90% over the simulated bandwidth. Similarly, the TM forward transmission percentage exceeds 80%. This shows that the device has an asymmetric total power transmission. The reflection spectrum is illustrated in FIG. 6. Ultimately, in an isolator very close to zero reflection is preferred regardless of the propagation direction. The TE polarization has less than 0.2% reflected regardless of the propagation direction. Moreover, TM polarization shows slightly less than 1.8% reflection regardless of the propagation direction. This data indicates that the photonic Tesla valve is polarization independent, which is expected based on the adiabatically tapered design.

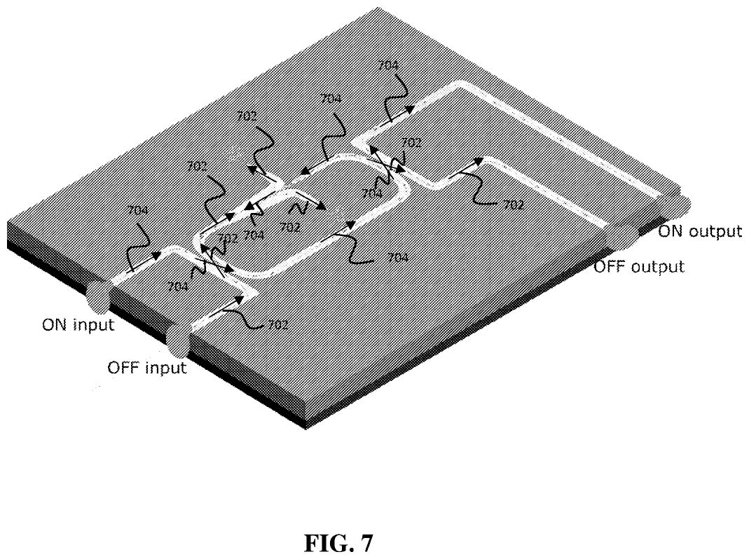

FIG. 7 shows an experimental design of the fabricated sample where the tesla valve is embedded into a racetrack. The line 702 indicates the path the rejected light takes, which splits the mode into two and leads them to randomly designed scattering pillars. The line 704 indicates the path the transmitted light takes.

Experimental characterization of a pseudo-isolator generally reduces to a measurement of optical loss in each propagation direction. In the context of integrated optics, this type of measurement is fraught because it is difficult to separate different sources of loss (e.g., coupling loss, scattering loss, absorption loss). One of the most reliable methods of characterizing waveguide loss involves measuring the quality factor of an optical ring resonator. This method is notable in that it is independent of input and output coupling efficiency, and therefore allows a precise characterization of the total round trip loss of the ring alone. Furthermore, it is suitable for measuring even small values of loss because on resonance the optical field circulates many times within the resonator. This is the approach method used to characterize the photonic Tesla valve. By embedding it in a ring, in theory the total loss of the device can be extracted. If the total ring size is minimized, the propagation loss of the waveguide will be small compared to the loss of the optical Tesla valve. Then the measured loss can be attributed to the device with minimal error. Such a ring resonator can be constructed in a way that allows easy measurement of both propagation directions simply by switching the input and output. While this method only provides characterization at the resonance wavelengths of the ring, these resonances occur periodically over a broad bandwidth and can be engineered to that their spacing provides a good sampling across the entire wavelength range.

The optical valve device (optical Tesla valve) is embedded into a racetrack resonator as shown in FIG. 7. This racetrack consists of a radius of 40 μm and a 100 μm straight waveguide, and a separation gap of 100 nm. In this approach, there are paths with different transmission values. To see this, consider the case indicated by the line 702 in FIG. 7. The input power is coupled to the racetrack using a standard evanescent coupler. From there it is split in two once it reaches the end of the Y-splitter. Then it is scattered by randomly placed pillars at the end of the tapered waveguide, which prevents the reflection of the light back into the resonator. If there is any power that could propagate from the Y-splitter to the small waveguide, then it can be measured through the OFF output waveguide. Another case is indicated by the line 704 in FIG. 7. The input power is coupled into the racetrack using a standard evanescent coupler. From there, there it propagates through the thin waveguide until it is tapered to a point source. This point source is then coupled into the large waveguide. Then it can be measured through the ON output waveguide.

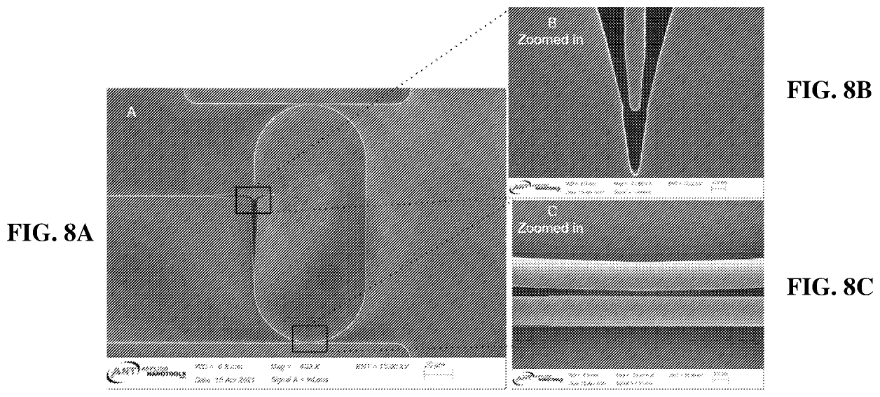

FIGS. 8A-8C show an electron micrograph of the fabricated photonic valve device. Specifically, FIG. 8A shows the photonic valve device placed in a ring resonator to characterize the optical loss. FIG. 8B shows a gap between Y-splitter and tapered waveguide. FIG. 8C shows evanescent coupler of the ring resonator.

In some embodiments of the disclosed technology, an optical valve device (optical Tesla valve) may be fabricated using a photonic integrated circuit fabrication method. In one example, a silicon on an insulator (SOI) wafer that includes a 500 nm device layer and a 3 μm bottom oxide layer (BOX) is used, and a design pattern is formed on e-beam resist using electron beam lithography (EBL). Inductively Coupled Plasma Etching (ICP-RIE) is employed to transfer the pattern from the E-beam resist into the silicon layer. The sample is cladded with a 3 μm SiO2 layer through plasma-enhanced chemical vapor deposition (PECVD). Each sample of the fabricated die is etched through substrate using an etching process to give a clean interface to the waveguide. A scanning electron microscope (SEM) image taken of the fabricated device is shown in FIGS. 8A-8C.

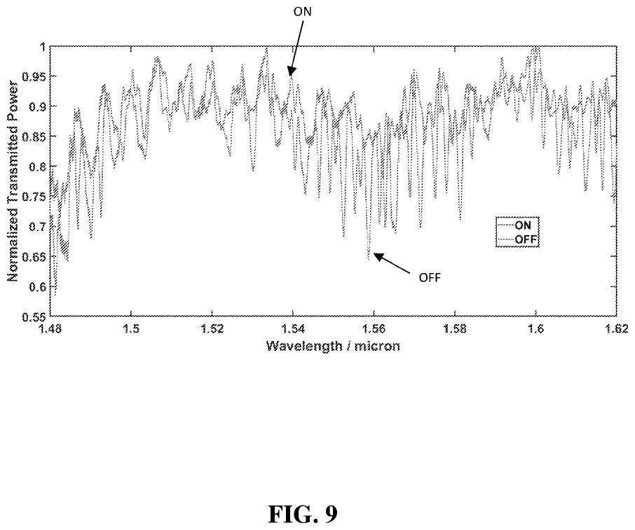

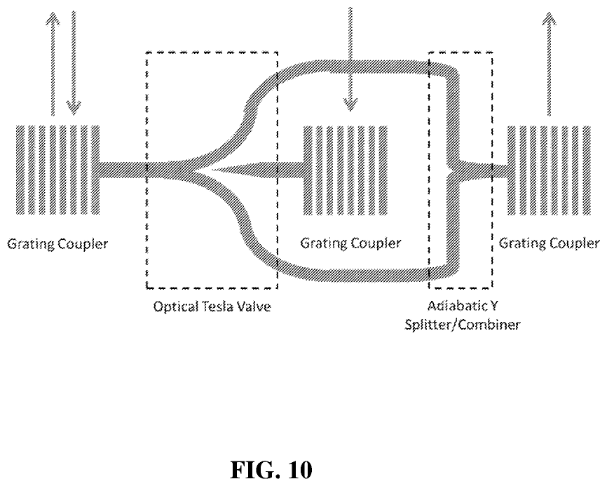

FIG. 9 shows experimental transmission spectra of the photonic valve device (photonic Tesla valve) contained within a ring resonator. The resonances of the ON state clearly have a higher Q-factor than that of the OFF state. This indicates they are lower loss, which is the anticipated behavior of the photonic Tesla valve. FIG. 10 shows an example of a circulator design using the optical tesla valve based on some embodiments of the disclosed technology.

In some embodiments of the disclosed technology, the device may be characterized using a fiber-to-fiber setup. In one example, the fiber-to-fiber setup uses a fiber coupled tunable laser as an input source, and a fiber coupled detector at the output. Coupling into the waveguide is achieved through lensed tapered fibers. Optical alignment is performed in the high transmission ON state, and interrogation of the low transmission OFF state is achieved by switching the input and output fibers at the laser and detector. The transmission spectrum of the device in both the on and off configurations is presented in FIG. 9. Although the coupling alignment is stable over the course of a single measurement sweep (sweep time on the order of 10 seconds), there is noticeable deviation between measurements (time between measurements on the order of minutes). For easier comparison, the individual spectrum are normalized to their point of maximum power. Note that the ring resonator experimental design was chosen specifically because the resonance line shape is independent of coupling efficiency.

An example of the experimental spectra is illustrated in FIG. 9. In reference to FIG. 7, the ON spectrum indicates the measurement path from “ON input” port to the “ON output” port. The OFF spectrum indicates the reverse path. The device performance is validated, as the ON and OFF spectra are clearly distinct from one another, which would not be the case in a reciprocal device. Furthermore, the resonances of the ON state clearly have a higher Q-factor than that of the OFF state. This indicates they are lower loss, which is the anticipated behavior of the photonic Tesla valve. In some implementations, the occurrence of the resonances is too close to allow for the precise calculation of the loss using the ring resonator method, because the resonance overlap prevents accurate calculation of the ring resonator depth, which is needed for determine the round trip cavity loss. In this case, it may be difficult to accurately determine the precise isolation ratio of the

Isolators are a critical optical component that can improve the performance of lasers by preventing the reflected light from destabilizing the gain cavity. Isolators may also improve the measurement precision in passive devices by preventing unwanted parasitic resonances. The disclosed technology can be implemented in some embodiments to provide a CMOS compatible optical valve device that behaves as a passive optical isolator. The optical valve device can achieve more than 45 dB isolation over a broad bandwidth with no applied electrical or magnetic fields. Moreover, the device dimension of the optical valve device is smaller than 10 μm×10 μm. Such a device can be fabricated with a single lithography step and is compatible with commercial CMOS foundries. It is also compatible with gain material and can be directly integrated with lasers and amplifiers. The optical valve device implemented based on some embodiments of the disclosed technology can be used as an indispensable staple of integrated photonics.

The disclosed technology can be implemented in some embodiments to provide an optical pseudo-isolator that offers significant isolation, wide bandwidth, and polarization independent operation. It is compact, compatible with CMOS and photonic foundry processes, and the device performance is comparable with commercial isolators. Given the current lack of integrated isolators, the optical pseudo-isolator based on some embodiments of the disclosed technology can impact applications such as optical communications, sensing, RF photonics. In some implementations, the optical pseudo-isolator optical pseudo-isolator may include a silicon-on-insulator based optical pseudo-isolator. In other implementations it may be extended to different material systems.

The disclosed technology can be implemented in some embodiments to provide a pseudo-isolator that operates using engineered spatial asymmetry to facilitate asymmetric transmission depending on the direction of the propagated mode. In one example, the pseudo-isolator may operate on a broadband bandwidth which exceeds 100 nm and occupies an area of less than 10 μm by 10 μm. Furthermore, the rejected (unwanted) mode remains confined, and can be routed away to avoid interaction with any propagating mode. Moreover, the design can be fabricated in a single lithography and etching process step, and is compatible with CMOS and photonic foundry fabrication processes. In some implementations, the pseudo-isolator is a linear system that operates independently of the total power level. Since the device operates over a vast bandwidth that covers both the L and C bands, it can be integrated with many existing lasers sources that are employed in data centers and optical telecommunication applications, which often demand high isolation to prevent destabilizing of the laser cavity and prevent amplification of the unwanted signal. In some implementations, the pseudo-isolator has higher isolation than most of the existing magneto-optic isolators.

As shown in FIG. 3, the photonic valve device may include a Y-splitter and a straight silicon waveguide separated by a small gap. When light is input into the left waveguide it exits the device through the transverse waveguides. When light is input into the right waveguide it is transmitted through to the left waveguide. Therefore the photonic valve device transmits light effectively when it travels from right to left, but rejects light when it travels from left to right. While the right waveguide is entirely single mode, the left waveguide becomes multimode as it tapers into the interface with the transverse waveguides. In some implementations, the isolation can be defined by referring to transmission from the fundamental TE-mode (or TM-mode) of the right waveguide to the corresponding fundamental mode of the left waveguide. The isolation of this design is mathematically represented as:

$$Isolation = \frac{{Transmisson}_{right to left direction}}{{Transmisson}_{left to right input direction} + {Reflection}_{right to left input direction}} \qquad ( 1 )$$

In some implementations, the behavior of the photonic valve device may be analyzed based on the scattering matrix. It is important to perform this analysis carefully, because it is counter-intuitive that isolation-like behavior can occur in a system composed of reciprocal materials that is linear, passive and time-invariant. Emphasis should be placed on the fact that the optical Tesla valve device does not conflict the reciprocity theorem. Physically this has the following meaning. Consider an input to the device that produces a particular output. If the output fields were to have their propagation direction reversed such that they were instead input into the device, the field that they would produce would the backward propagating version of the original input. Essentially, the loophole that allows isolation-like behavior (or pseudo-isolation) to occur results from the ability to restrict the ports of the device such that some can be used as outputs but not as inputs. Consequently if some output fields corresponding to some input cannot be reversed, then the input cannot be reconstructed by reciprocity. In the optical Tesla valve the restricted ports are the transverse ports. Any energy exiting them can be scattered into free space or they can be terminated in an absorber. By encasing the device or otherwise obscuring the ports, the possibility of using them as reciprocal inputs can be eliminated. The device will therefore respond in an asymmetric manner that is suitable for the same engineering purposes as a conventional isolator. Mathematically, the phenomenon of pseudo-isolation is best understood in terms of scattering matrices, which is the focus of this section.

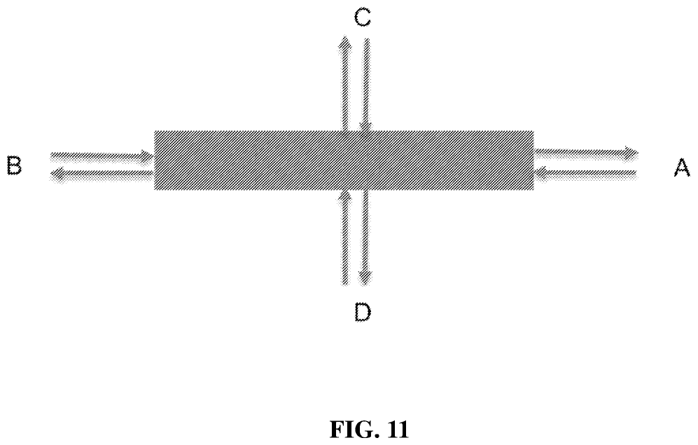

FIG. 11 shows an example of the optical valve device, where A and B are the input and the output port and C and D are the scattering ports.

To understand the optical valve device in terms of scattering matrices, consider the conceptual model of FIG. 11. The optical valve device consists of ports A and B; both can be arbitrary input or output, and scattering ports are denoted as C and D.

From FIG. 11, the scattering matrix can be written as:

$$[ \begin{matrix}{A}_{out} \\ {B}_{out} \\ {C}_{out} \\ {D}_{out}\end{matrix} ] = S [ \begin{matrix}{A}_{in} \\ {B}_{in} \\ {C}_{in} \\ {C}_{in}\end{matrix} ] \qquad ( 2 )$$

where Aᵢₙ and Aₒᵤₜ are input and output signals from port A. Similarly, Bᵢₙ and Bₒᵤₜ out are the input and output from port B, respectively. Likewise, Cᵢₙ and Cₒᵤₜ are the input and output from port C, respectively. In the case of forward propagation, where the mode propagates from the right waveguide to the left waveguide, the only nonzero input signal is from Aᵢₙ and the outputs are Aₒᵤₜ, Bₒᵤₜ₁, Cₒᵤₜ₁ and Dₒᵤₜ₁. Thus, the matrix can be written as:

$$[ \begin{matrix}{a}_{out 1} \\ {b}_{out} \\ {c}_{out 1} \\ {d}_{out 1}\end{matrix} ] = S [ \begin{matrix}{a}_{in 0} \\ 0 \\ 0 \\ 0\end{matrix} ] \qquad ( 3 )$$

From Eq.2, the system is reciprocal with respect to time-reversal symmetry, especially since the optical valve device is both LTI and passive system. The aₒᵤₜ₁ value is negligible, as shown in FIG. 6 (left input TE), compared to bₒᵤₜ. Moreover, cₒᵤₜ₁ and dₒᵤₜ values are also negligible according to the simulated results. Knowing that Eq.3 can be rewritten as:

$$[ \begin{matrix}0 \\ {b}_{out 1} \\ 0 \\ 0\end{matrix} ] = S [ \begin{matrix}{a}_{in 0} \\ 0 \\ 0 \\ 0\end{matrix} ] \qquad ( 4 )$$

This result is confirmed in FIGS. 5 and 6, which state that the optical valve device is not strictly reciprocal but behaves as an isolator due to the spatial variant nature of the optical valve device. Since the design is symmetric, The scattering matrix is S=S^{T} and satisfies energy conservation and thus written as:

$${S}^{*} = {S}^{- 1} \qquad ( 5 )$$

Now assume that the output signal is reversed and is the input at port B; the scattering matrix can be written as:

$$S [ \begin{matrix}{a}_{out 1}^{⋆} \\ {b}_{out 1}^{⋆} \\ {c}_{out 1}^{⋆} \\ {d}_{out 1}^{⋆}\end{matrix} ] = {( {S}^{⋆} [ \begin{matrix}{a}_{out 1} \\ {b}_{out 1} \\ {c}_{out 1} \\ {d}_{out 1}\end{matrix} ] )}^{⋆} = {( {S}^{- 1} [ \begin{matrix}{a}_{out 1} \\ {b}_{out 1} \\ {c}_{out 1} \\ {d}_{out 1}\end{matrix} ] )}^{⋆} = {[ \begin{matrix}{a}_{in}^{⋆} \\ 0 \\ 0 \\ 0\end{matrix} ]}^{⋆} \qquad ( 6 )$$

The results from Eq.6 and Eq.2 are identical, which means when we reverse all the output signals, there is no isolation behavior. This also confirms the device obeys the reciprocity theorem, as expected. However, when considering the design of the optical valve device, as seen in FIG. 7, the output from the end of the two-end tapered Y-splitter is scattered using scattering structure and, in all practical cases, cannot be reversed. Thus for our structure Cᵢₙ and dᵢₙ may be taken to identically be zero. In this case Eq.6 becomes:

$$[ \begin{matrix}0 \\ {b}_{in}^{*} \\ 0 \\ 0\end{matrix} ] = S [ \begin{matrix}{a}_{out 2} \\ {b}_{out 2} \\ {c}_{out 2} \\ {d}_{out 2}\end{matrix} ] \qquad ( 7 )$$

The scattering matrices of Eq. 7 and Eq.4 are related by the term bᵢₙ₁ and its complex conjugate (which represents a reversal of propagation direction). Comparison of the two expressions indicates there will be a clear asymmetry in the response of the device. This is how pseudo-isolation is achieved in the optical valve device. Due to this, the output signal from port B when reversed does not return to port A but instead is output at ports C and D. With ideal structure, both bₒᵤₜ₂ and dₒᵤₜ₂ equals to zero, thus the equal to:

$$[ \begin{matrix}0 \\ {b}_{out 1}^{*} \\ 0 \\ 0\end{matrix} ] = S [ \begin{matrix}0 \\ 0 \\ {c}_{out 2} \\ {d}_{out 2}\end{matrix} ] \qquad ( 8 )$$

This is precisely the behavior predicted by the numerical simulations of the device. This is a strong validation that the optical valve device based on engineered asymmetric spatial variation results in pseudo-isolation behavior.

As discussed above, the disclosed technology can be implemented in some embodiments to provide a passive, linear, time-invariant device that behaves like a pseudo-isolator. In some embodiments, the pseudo-isolator is realized by engineering a spatially asymmetric device that permits optical propagation in one direction but prevents optical propagation in the opposite direction by redirecting it using a pair of transverse waveguides in a Y-splitter configuration. In some embodiments, the pseudo-isolator has significant isolation for both TE and TM polarizations, and operates over an extremely wide bandwidth. The device itself is extremely compact and compatible with CMOS and photonic foundry fabrication processes. This is a unique property that will make it a standard component going forward.

In some implementations, the optical valve device is predicted to exhibit a 49 dB isolation ratio, which is more than two times higher than commercial magneto-optic isolators. Moreover, in some implementations, the optical valve device may have more than 100 nm bandwidth that covers both L and C without any reconfiguration. Competitive designs typically only cover 10-20 nm bandwidth.

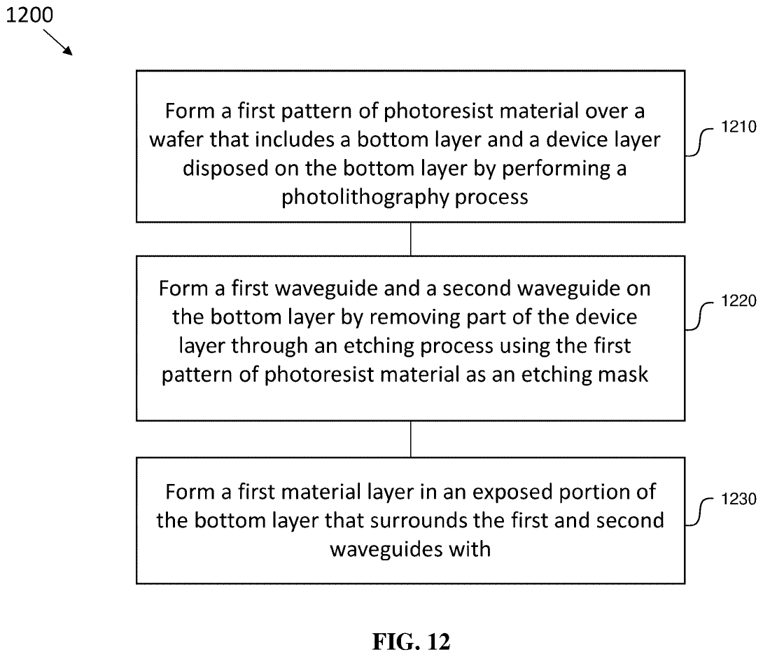

FIG. 12 shows an example method 1200 of forming an optical device based on some implementations of the disclosed technology.

In some implementations of the disclosed technology, the method 1200 may include, at 1210, forming a first pattern of photoresist material over a wafer that includes a bottom layer and a device layer disposed on the bottom layer by performing a photolithography process, at 1220, forming a first waveguide and a second waveguide on the bottom layer by removing part of the device layer through an etching process using the first pattern of photoresist material as an etching mask, and at 1230, forming a first material layer in an exposed portion of the bottom layer that surrounds the first and second waveguides. In some implementations, the second width is smaller than the first width.

Therefore, various implementations of features of the disclosed technology can be made based on the above disclosure, including the examples listed below.

Example 1. An optical device, comprising: a first waveguide having a first width and including a body section and two or more tapering arm sections connected to the body section at a junction section, each tapering arm section connected to the body section through a bent section; and a second waveguide having a second width and including a first end spaced apart from the junction section of the first waveguide by a first gap.

Example 2. The device of example 1, wherein the second width is smaller than the first width.

Example 3. The device of example 1, wherein the first waveguide includes a Y-splitter.

Example 4. The device of example 1, wherein the second waveguide includes a straight waveguide.

Example 5. The device of example 1, wherein the second waveguide and the body section of the first waveguide are arranged in a first direction, and the two or more tapering arm sections is arranged in a second direction.

Example 6. The device of example 1, wherein the second waveguide and the body section of the first waveguide are arranged in a first direction, and two or more tapering arm sections includes a first tapering arm section and a second tapering arm section, wherein at least part of the first tapering arm section and at least part of the second tapering arm section are arranged in a second direction.

Example 7. The device of any of examples 5-6, wherein the first direction is perpendicular to the second direction.

Example 8. The device of example 1, wherein the first end of the second waveguide tapers toward the junction section of the first waveguide.

Example 9. The device of example 1, wherein light incident from the second waveguide is transmitted across the gap to the first waveguide, and light incident from the first waveguide is directed laterally toward the two or more tapering arm sections.

Example 10. The device of example 1, wherein each tapering arm section includes a pointed end structured to prevent a reflection of light back into the first waveguide.

Example 11. A method of forming an optical device, comprising: forming a first pattern of photoresist material over a wafer that includes a bottom layer and a device layer disposed on the bottom layer by performing a photolithography process; forming a first waveguide and a second waveguide on the bottom layer by removing part of the device layer through an etching process using the first pattern of photoresist material as an etching mask; and forming a first material layer in an exposed portion of the bottom layer that surrounds the first and second waveguides, wherein the first waveguide has a first width and includes a body section and two or more tapering arm sections connected to the body section at a junction section, and each tapering arm section is connected to the body section through a bent section, wherein the second waveguide has a second width and includes a first end spaced apart from the junction section of the first waveguide by a first gap, wherein the second width is smaller than the first width.

Example 12. The method of example 11, wherein the second width is smaller than the first width.

Example 13. The method of example 11, wherein the wafer is a silicon on insulator (SOI) wafer.

Example 14. The method of example 11, wherein the bottom layer includes an insulating material, and the device layer includes silicon.

Example 15. The method of example 11, wherein the photolithography process includes an electron beam lithography process.

Example 16. The method of example 11, wherein the etching process includes an inductively coupled plasma etching (ICP-RIE).

Example 17. The method of example 11, wherein the first material layer is formed by performing a plasma-enhanced chemical vapor deposition (PECVD).

Example 18. The method of example 11, wherein the first waveguide includes a Y-splitter, and the second waveguide includes a straight waveguide.

Example 19. An optical device, comprising: a plurality of unit optical devices; and a plurality of optical combiners configured to connect the plurality of unit optical devices in cascade, wherein each of the plurality of unit optical devices comprises: a first waveguide having a first width and including a body section and two or more tapering arm sections connected to the body section at a junction section, each tapering arm section connected to the body section through a bent section; and a second waveguide having a second width and including a first end spaced apart from the junction section of the first waveguide by a first gap.

Example 20. The device of example 19, wherein the second width is smaller than the first width.

Example 21. The device of example 19, further comprising a plurality of tunable light sources that is isolated from each other.

Example 22. The device of example 19, wherein the first waveguide includes a Y-splitter.

Example 23. The device of example 19, wherein the second waveguide includes a straight waveguide.

Example 24. The device of example 19, wherein the second waveguide and the body section of the first waveguide are arranged in a first direction, and the two or more tapering arm sections is arranged in a second direction.

Example 25. The device of example 19, wherein the second waveguide and the body section of the first waveguide are arranged in a first direction, and two or more tapering arm sections includes a first tapering arm section and a second tapering arm section, wherein at least part of the first tapering arm section and at least part of the second tapering arm section are arranged in a second direction.

Example 26. The device of any of examples 24-25, wherein the first direction is perpendicular to the second direction.

Example 27. The device of example 19, wherein the first end of the second waveguide tapers toward the junction section of the first waveguide.

Example 28. The device of example 19, wherein light incident from the second waveguide is transmitted across the gap to the first waveguide, and light incident from the first waveguide is directed laterally toward the two or more tapering arm sections.

Example 29. The device of example 19, wherein each tapering arm section includes a pointed end structured to prevent a reflection of light back into the first waveguide.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. An optical device, comprising:
a first waveguide having a first width and including a body section and two or more tapering arm sections connected to the body section at a junction section, each tapering arm section connected to the body section through a bent section; and
a second waveguide having a second width and including a first end spaced apart from the junction section of the first waveguide by a first gap.

2. The device of claim 1, wherein the second width is smaller than the first width.

3. The device of claim 1, wherein the first waveguide includes a Y-splitter.

4. The device of claim 1, wherein the second waveguide includes a straight waveguide.

5. The device of claim 1, wherein the second waveguide and the body section of the first waveguide are arranged in a first direction, and the two or more tapering arm sections is arranged in a second direction.

6. The device of claim 1, wherein the second waveguide and the body section of the first waveguide are arranged in a first direction, and two or more tapering arm sections includes a first tapering arm section and a second tapering arm section, wherein at least part of the first tapering arm section and at least part of the second tapering arm section are arranged in a second direction.

7. (canceled)

8. The device of claim 1, wherein the first end of the second waveguide tapers toward the junction section of the first waveguide.

9-10. (canceled)

11. A method of forming an optical device, comprising:
forming a first pattern of photoresist material over a wafer that includes a bottom layer and a device layer disposed on the bottom layer by performing a photolithography process;
forming a first waveguide and a second waveguide on the bottom layer by removing part of the device layer through an etching process using the first pattern of photoresist material as an etching mask; and
forming a first material layer in an exposed portion of the bottom layer that surrounds the first and second waveguides,
wherein the first waveguide has a first width and includes a body section and two or more tapering arm sections connected to the body section at a junction section, and each tapering arm section is connected to the body section through a bent section,
wherein the second waveguide has a second width and includes a first end spaced apart from the junction section of the first waveguide by a first gap, wherein the second width is smaller than the first width.

12. The method of claim 11, wherein the second width is smaller than the first width.

13. The method of claim 11, wherein the wafer is a silicon on insulator (SOI) wafer.

14. The method of claim 11, wherein the bottom layer includes an insulating material, and the device layer includes silicon.

15. The method of claim 11, wherein the photolithography process includes an electron beam lithography process.

16. The method of claim 11, wherein the etching process includes an inductively coupled plasma etching (ICP-RIE).

17-18. (canceled)

19. An optical device, comprising:
a plurality of unit optical devices; and
a plurality of optical combiners configured to connect the plurality of unit optical devices in cascade,
wherein each of the plurality of unit optical devices comprises:
a first waveguide having a first width and including a body section and two or more tapering arm sections connected to the body section at a junction section, each tapering arm section connected to the body section through a bent section; and
a second waveguide having a second width and including a first end spaced apart from the junction section of the first waveguide by a first gap.

20. The device of claim 19, wherein the second width is smaller than the first width.

21. The device of claim 19, further comprising a plurality of tunable light sources that is isolated from each other.

22. The device of claim 19, wherein the first waveguide includes a Y-splitter.

23. The device of claim 19, wherein the second waveguide includes a straight waveguide.

24. The device of claim 19, wherein the second waveguide and the body section of the first waveguide are arranged in a first direction, and the two or more tapering arm sections is arranged in a second direction.

25. The device of claim 19, wherein the second waveguide and the body section of the first waveguide are arranged in a first direction, and two or more tapering arm sections includes a first tapering arm section and a second tapering arm section, wherein at least part of the first tapering arm section and at least part of the second tapering arm section are arranged in a second direction.

26-29. (canceled)
